(19) United States
(12) Patent Application Publication
(10) Pub. No.: US 2014/0032300 A1
(43) Pub. Date: Jan. 30, 2014

(54) Method and System for Debt Resolution Restricted Offer

(71) Applicants: Ye Zhang, West Chester, PA (US); Vytas Kisielius, Wilton, CT (US); Garrett Baird, Philadelphia, PA (US)

(72) Inventors: Ye Zhang, West Chester, PA (US); Vytas Kisielius, Wilton, CT (US); Garrett Baird, Philadelphia, PA (US)

(73) Assignee: Collections Marketing Center, Inc.

(21) Appl. No.: 13/559,708

(22) Filed: Jul. 27, 2012

(51) Int. Cl. G06Q 20/14; G06Q 30/02; G06Q 40/02

(52) U.S. Cl. 705/14.35; 705/38; 705/14.1

(57) ABSTRACT

Various systems, computer program products, and methods for resolving financial issues using conditional debt resolution offers are described. A method may include determining a debtor that is to receive a conditional debt resolution offer. In some implementations, the conditional debt resolution offer is subject to a condition for the conditional debt resolution offer to be valid. When valid and accepted by the debtor, the conditional debt resolution offer at least partially resolves the debt. In some implementations, the method may include causing the conditional debt resolution offer to be communicated to the debtor. In some implementations, the method may include determining whether the condition has been satisfied. In some implementations, the method may include validating the conditional debt resolution offer when the condition has been satisfied or invalidating the conditional debt resolution offer when the condition has not been satisfied.

### FIELD OF THE INVENTION

The disclosure relates to debt resolution and in particular to debt resolution offers that are restricted by time, number of offers, and/or other conditions.

### BACKGROUND OF THE INVENTION

When a debtor becomes delinquent or is in danger of becoming delinquent on a debt, creditors, debt collectors or others may attempt to collect the debt by offering various debt resolution options. For example, conventional debt resolution systems may offer a particular payment plan that resolves the debt. However, oftentimes the debtor ignores or is otherwise unmotivated to accept the offered payment plan.

By merely offering different payment options, conventional debt resolution systems fail to adequately incent the debtor to resolve their debt. For example, conventional debt resolution systems fail to offer debtors an opportunity to resolve a debt with a discount and/or other incentive if the offer is accepted within a limited time frame, before a certain number of responses to the offer are received, and/or other condition is met. By failing to provide appropriate incentives to resolve a debt, conventional debt resolution systems fail to provide motivation for the debtor to resolve the debt.

These and other problems exist, which causes conventional systems and debt collection efforts based on those systems to be more expensive and ultimately less effective for the users of those systems.

### SUMMARY OF THE INVENTION

Various systems, computer program products, and methods for resolving financial issues using conditional debt resolution offers are described. For example, a method may include determining a debtor that is to receive a conditional debt resolution offer. In some implementations, the conditional debt resolution offer is subject to a condition for the conditional debt resolution offer to be valid. In some implementations, for example, the condition may include an expiration date (such as a respond-by date), a cap on the number of debtors who may accept the offer, or a minimum number of debtors who must accept the offer for the offer to be valid. When valid and accepted by the debtor, the conditional debt resolution offer at least partially resolves the debt. In this manner, the offer incents the debtor to respond before the expiration date, respond before the offer becomes unavailable, or “activate” the offer by together with other debtors providing a sufficient number of responses to meet the minimum number of acceptances. In some implementations, the method may include causing the conditional debt resolution offer to be communicated to the debtor. In some implementations, the method may include determining whether the condition has been satisfied. In some implementations, the method may include validating the conditional debt resolution offer when the condition has been satisfied or invalidating the conditional debt resolution offer when the condition has not been satisfied.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 is a block diagram illustrating a system for providing a conditional debt resolution offer to resolve a debt, according to various implementations of the invention.

FIG. 2 is a block diagram illustrating various channels used by conditional offer server for communicating conditional debt resolution offers, according to various implementations of the invention.

FIG. 3 is a block diagram illustrating different groups of debtors receiving different conditional debt resolution offers, according to various implementations of the invention.

FIG. 4 is a block diagram illustrating a rules-based engine for conditional debt resolution offers, according to various implementations of the invention.

FIG. 5 is a block diagram illustrating an effectiveness engine for rating effectiveness of conditional debt resolution offers or communication channels, according to various implementations of the invention.

FIG. 6 is a schematic representation of conditional debt resolution offers associated with different incentives, according to various implementations of the invention.

FIG. 7 is a flow diagram illustrating an example of a process for providing a conditional debt resolution offer for resolving a debt, according to various implementations of the invention.

### DETAILED DESCRIPTION OF THE INVENTION

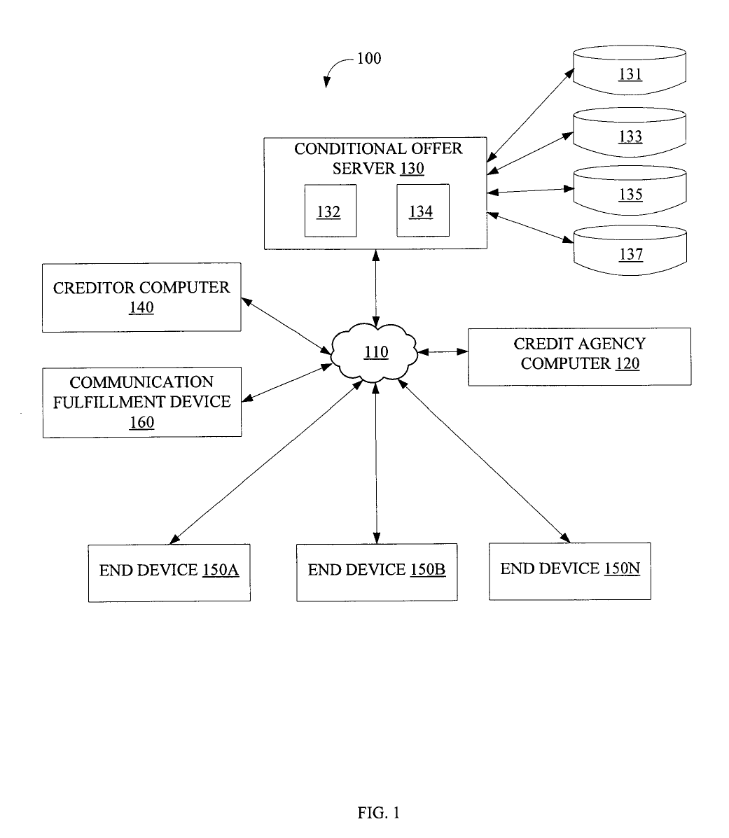

FIG. 1 is a block diagram illustrating a system 100 for providing a conditional debt resolution offer to resolve a debt, according to various implementations of the invention. According to various implementations of the invention, system 100 may communicate conditional debt resolution offers to resolve a debt. Each conditional debt resolution offer may be subject to a condition in order for the offer to be valid. For example, a conditional debt resolution offer may include, without limitation, a time-limited offer that expires after a particular amount of time has elapsed or after a particular date/time has passed, an offer that is no longer valid after being accepted by more than a maximum number of times (i.e., has a cap), an offer that must be accepted by more than a minimum number of times (i.e., has a floor), and/or other offer that is contingent on a condition for the offer to be valid. A “valid” offer is one that may be accepted by a debtor to partially or fully resolve a debt. On the other hand, an “invalid” offer is one that may not be accepted by the debtor to partially or fully resolve the debt.

In some implementations, debtors may be incented to respond to a conditional debt resolution offer if they know that the offer is limited by time or number of debtors who may respond to/accept the offer (such as is the case with time-limited or capped offers). In some implementations, debtors may be incented to respond to a conditional debt resolution offer if they know that a particular number of responses must be achieved in order for the offer to be valid (such as is the case with a floored offer). In this manner, various conditional debt resolution offers may increase the number of debtors who respond to offers to resolve debt.

The foregoing are non-limiting examples associated with various implementations of the invention. Other uses and implementations of system 100 with respect to various system components will be apparent to those skilled in the art based on the description below.

According to various implementations of the invention, system 100 may include, but is not limited to, a conditional offer server 130, a credit agency computer 120, a creditor computer 140, an end device 150 (illustrated in FIG. 1 as end devices 150A, 150B, . . . , 150N), and communication fulfillment device 160. In some implementations of the invention, conditional offer server 130 may include or otherwise be coupled to attribute database 131, conditional offer database 133, rules database 135, and offer results database 137. In some implementations of the invention, conditional offer server 130, attribute database 131, conditional offer database 133, rules database 135, offer results database 137, credit agency computer 120, creditor computer 140, end device 150, and communication fulfillment device 160 may be communicably coupled to one another via a network 110. Network 110 may include a Local Area Network, a Wide Area Network, a cellular communications network, a Public Switched Telephone Network, and/or other network or combination of networks. In some implementations of the invention, end device 150 may include, without limitation, a telephone, a computer, a smartphone, a cellular phone, tablet computer, print shop and/or other device that can be used to contact debtors over network 110.

In some implementations of the invention, credit agency computer 120 provides provide credit scores, credit histories, and other information about debtors from a credit reporting agency or bureau. Credit agency computer 120 may include, for example, various devices and memories (not illustrated in FIG. 1) that store and make available such information to conditional offer server 130.

In some implementations of the invention, creditor computer 140 provides payment histories, debts owed, credit limits, delinquency, and other information regarding debts owed by debtors to creditors. In some implementations, creditor computer 140 may include a creditor's system of record (SOR) which provides information regarding debts owed by debtors to creditors. Creditor computer 140 may include, for example, various devices and memories (not illustrated in FIG. 1) that store and make available such information to conditional offer server 130.

In some implementations, system 100 may include a third-party computer (not otherwise illustrated in FIG. 1) associated with a third-party (non-credit) agency. In some implementations, the third-party computer may provide data associated with debtors obtained by, for example, performing a skip tracing process to locate a debtor and/or collect information regarding a debtor. Third-party computer may include, for example, various devices and memories that store and make available such information to conditional offer server 130.

In some implementations of the invention, communication fulfillment device 160 provides indications of prior communication with the debtor. In some implementations, such prior communication may indicate prior behavior of the debtor. For example, communication fulfillment device 160 may provide data associated with a call using an IVR system with the debtor, an indication of the websites that were visited by the debtor, and/or other communications with the debtor. In some implementations, communication fulfillment device 160 provides an indication of whether a debtor has accepted a conditional debt resolution offer.

In some implementations of the invention, conditional offer server 130 may obtain an attribute of a debtor. In some implementations of the invention, the attribute describes a prior history or action/behavior of the debtor. For example, the attribute may include a financial attribute such as, without limitation, a credit score or history (such as a score or history from a credit reporting agency), a payment history, or a behavioral attribute that indicates a behavior or action by the debtor. The prior behavior may include, without limitation, contacting a creditor or debt collector regarding a debt owed, visiting a website of the creditor or debt collector, making a prior promise to pay, and/or other behavior by the debtor in relation to a debt owed.

In some implementations of the invention, the attribute is obtained dynamically from an attribute source such as credit agency computer 120, creditor computer 140, communication fulfillment device 160, or third-party computer. In some implementations of the invention, the attribute is obtained periodically and stored in attribute repository 131. In these implementations, attribute repository 131 may be updated periodically. In this manner, system 100 may dynamically obtain attributes of a debtor in real-time and/or may obtain attributes from storage (which can be updated periodically as updated information becomes available—such as when a change in credit score has occurred).

In some implementations of the invention, conditional offer database 133 may include a plurality of conditional offers to resolve financial issues. In some implementations of the invention, a creditor may add, update, or remove conditional offers to/from conditional offer database 133. In some implementations of the invention, added, updated, or removed conditional offers may be used in or removed from the available pool of conditional offers in real-time. In some implementations, the conditional offers may be one-time offers or offers that may be used more than once. In some implementations, a conditional offer may be generated and provided by creditors to be communicated to a debtor. In other implementations, a conditional offer may be generated on behalf of a creditor to be communicated to a debtor. In some implementations, a conditional offer may be generated by a daily batch process. In other implementations, a conditional offer may be generated in real time. In some implementations, a creditor may select which ones of the conditional offers to communicate to a debtor (such as by defining a rule, discussed below, or by directly selecting conditional offers to communicate) and in which order.

In some implementations of the invention, rules database 135 may include a plurality of rules that specify whether and how to make (i.e., communicate) conditional offers. In some implementations of the invention, a creditor may add, update, or remove rules from rules database 135. In some implementations of the invention, added, updated, or removed rules may immediately control outcomes, affecting in real-time which conditional offers are communicated.

In some implementations of the invention, a rule includes one or a logical combination of variables that define further actions system 100 should take. For example, a rule may specify which conditional offer(s) may be appropriate for a particular debtor. In particular, a rule may specify a conditional offer based on an attribute of a debtor. In other words, a rule may specify which conditional offers should be communicated to a given debtor and/or group of debtors. In some implementations, a rule may specify a particular communication channel and/or a particular sequence of more than one communication channels in which a conditional offer should be communicated. In some implementations, a rule may specify a combination of a conditional offer and a communication channel or a particular sequence of more than one communication channels to use when communicating the conditional offer.

In some implementations of the invention, offer results database 137 may include various statistics associated with conditional offers. Offer results database 137 may be used to view historical responses by various debtors to different conditional offers. In some implementations of the invention, whether a conditional offer is effective at obtaining an acceptance or response from the debtor may be determined based on the historical responses. Using statistics stored by offer results database 137, the success of various conditional offers may be determined.

In some implementations, the statistics may include an indication of whether a conditional offer was validated (i.e., a corresponding condition was met) or invalidated (i.e., a corresponding condition was not met). For example, offer results database 137 may store information that indicates the condition (such as a two-week period after which the offer expires) and whether such condition was met such (such as whether the debtor who was given the conditional offer responded before the offer expired). In another example, offer results database 137 may store a number of debtors who responded to a conditional offer having a cap. For example, offer results database 137 may store a condition such as “first 100 to respond” (i.e., a cap of 100 acceptances) receives the conditional offer to resolve their debt. In this example, offer results database 137 may store the number of debtors who actually responded. In this manner, the stored data may be used to determine the success of the conditional offer.

In some implementations, the statistics may include a number of the conditional offers that were communicated to debtors. In this manner, the statistics may indicate a percentage of the conditional offers that were communicated that resulted in responses. For example, the statistics may indicate that a conditional offer “first 100 to respond” was communicated to 5,000 debtors and that 500 debtors responded (the conditional offer was invalid for the 400 late responders). In this example, a determination may be made that the “first 100 to respond” conditional offer had a 10% success rate (500 responses out of 5,000 offers).

In some implementations of the invention, conditional offer server 130 may determine a debtor that is to receive a conditional debt resolution offer. For example, conditional offer server 130 may determine the debtor based on rules, debtor attributes, and/or an indication from a creditor to offer the debtor a conditional offer. In some implementations, different debtors will receive the same conditional offer to resolve their debts. In some implementations, particular debtors may receive customized conditional offers to resolve their debts. In some implementations, the conditional offers may be individually customized (i.e., for a single debtor) while in other implementations the conditional offers may be customized for a group of debtors.

In some implementations of the invention, conditional offer server 130 may determine the group of debtors who will receive the conditional debt resolution offer. In some implementations, various debtors may be placed into different groups based on, without limitation, a rule, a debtor attribute, and/or an indication from a creditor to make such groupings. In some implementations, different groups may be targeted to receive different conditional offers.

In some implementations of the invention, conditional offer server 130 may cause the conditional debt resolution offer to be communicated to the debtor (or debtors). In some implementations, conditional offer server 130 may communicate the conditional debt resolution offer directly to the debtor or indirectly via one or more third parties. In some implementations, the conditional debt resolution offer may be communicated by various communication channels or combination of communication channels. For example, conditional offer server 130 may cause a text message (such as a Short Message Service (“SMS”) text message), an email, an Interactive Voice Response (“IVR”) phone call, a live agent phone call, a social network post (such as comments, private messages, etc.), an instant-message (any one or more of which may include the conditional debt resolution offer), or regular mail to be communicated to the debtor. In some implementations, conditional offer server 130 may communicate the conditional debt resolution offer without the debtor subscribing to a service to receive such offers. In other words, in these implementations, any debtor may be identified to receive such conditional offers.

In some implementations of the invention, conditional offer server 130 may cause a protected text message to be communicated to the debtor. In some implementations, the protected text message may be encrypted or password-protected. For example, a private key may have been set up between a debtor's end device 150 and creditor computer 140 and/or with conditional offer server 130 such that encrypted communication may occur. In another example, a password or other secret/identification code may have been previously or subsequently communicated to the debtor in order for the debtor to access a password-protected text message. In this manner, the debtor may receive secure conditional debt resolution offers. In some implementations, upon unlocking a password protected text message by valid password entry, the text message may cause the conditional debt resolution offer to be communicated to the debtor. In some implementations, the text message communicates the conditional debt resolution offer by displaying the offer directly via the same or follow-up text message. In some implementations, the text message communicates the conditional debt resolution offer by causing a Uniform Resource Locator (“URL”) to be communicated to the debtor, where navigating to the URL causes the conditional offer to be communicated. For example, the URL may link to a web page associated with conditional offer server 130.

In some implementations of the invention, conditional offer server 130 may determine whether the condition has been satisfied. In some implementations, conditional offer server 130 may make the determination at various times, such as periodically or when an acceptance of a conditional offer is received from the debtor. In some implementations, conditional offer server 130 may determine whether an expiration date of a conditional offer has passed. In this example, the expiration date of a conditional debt resolution offer may be stored and retrieved to determine whether the expiration date has passed. In some implementations, conditional offer server 130 may determine whether a conditional period for reply has elapsed. In this example, the date/time during which the conditional debt resolution offer was made and the period for reply may be stored and retrieved to determine whether that period for reply has expired. In some implementations, conditional offer server 130 may store a cap or floor of the number of responses associated with a capped conditional debt resolution offer or a floored conditional debt resolution offer. In these examples, conditional offer server 130 may determine a number of responses to the conditional debt resolution offer that were received to determine whether the cap has been exceeded or whether the floor has been achieved.

The foregoing examples of conditions and determining whether such conditions have been satisfied are for illustrative purposes only. Other conditions and corresponding determinations may be made as would be appreciated. Regardless of the particular type of conditional debt resolution offer that was made, in some implementations, conditional offer server 130 may validate the conditional debt resolution offer when the condition has been satisfied or invalidate the conditional debt resolution offer when the condition has not been satisfied. In some implementations, validation or invalidation of the conditional offer may occur before an acceptance/response to the conditional offer is received from the debtor. In some implementations, validation or invalidation of the conditional offer may occur after an acceptance/response to the conditional offer is received from the debtor.

In some implementations of the invention, conditional offer server 130 may receive an indication that the conditional debt resolution offer has been accepted by the debtor. For example, the debtor may logon to a website associated with the conditional debt resolution offer and accept the conditional offer via the website. As previously noted, in some implementations, the conditional offer is already validated or invalidated when the indication has been received while in other implementations, the conditional offer is validated or invalidated upon receipt of the indication.

In some implementations of the invention, conditional offer server 130 may cause at least a partial resolution of the debt based on the conditional debt resolution offer when the conditional debt resolution offer has been validated. In other implementations, conditional offer server 130 may cause a rejection of the conditional debt resolution offer when the conditional debt resolution offer has been invalidated. For example, if the debtor responded too late to a limited-time offer, conditional offer server 130 may refuse the acceptance of the conditional offer by the debtor. Similarly, if a maximum number of acceptances to a capped offer has already been received, conditional offer server 130 may refuse the acceptance.

In some implementations of the invention, conditional offer server 130 may communicate an incentive to accept the conditional debt resolution offer. In some implementations, the incentive may include, without limitation, a monetary incentive such as a discount off an amount of debt that is owed, a financial incentive such as an offer for another financial instrument, an offer to receive a good or other service, and/or other incentive for the debtor to accept the conditional debt resolution offer.

In some implementations, the incentive may be associated with the same condition associated with the conditional debt resolution offer. For example, the conditional debt resolution offer may be valid only for the first 200 responders as well as offer a 10% discount incentive to the first 200 responders. In this example, the 10% off incentive is tied to a condition that caps the number of responses to 200.

In some implementations, the incentive may be associated with a different condition than the condition associated with the conditional debt resolution offer. For example, the conditional debt resolution offer may include a “limited time only” condition to resolve a debt and provide an incentive that the first 100 responders will receive a 10% discount off a debt owed. In this example, the offer condition associated with the conditional debt resolution offer (limited time) is different than the incentive condition associated with the incentive (first 100 responders) such that the 101st responder may still have an opportunity to accept the debt resolution offer without the discount as long as the response is made before expiration of the limited time.

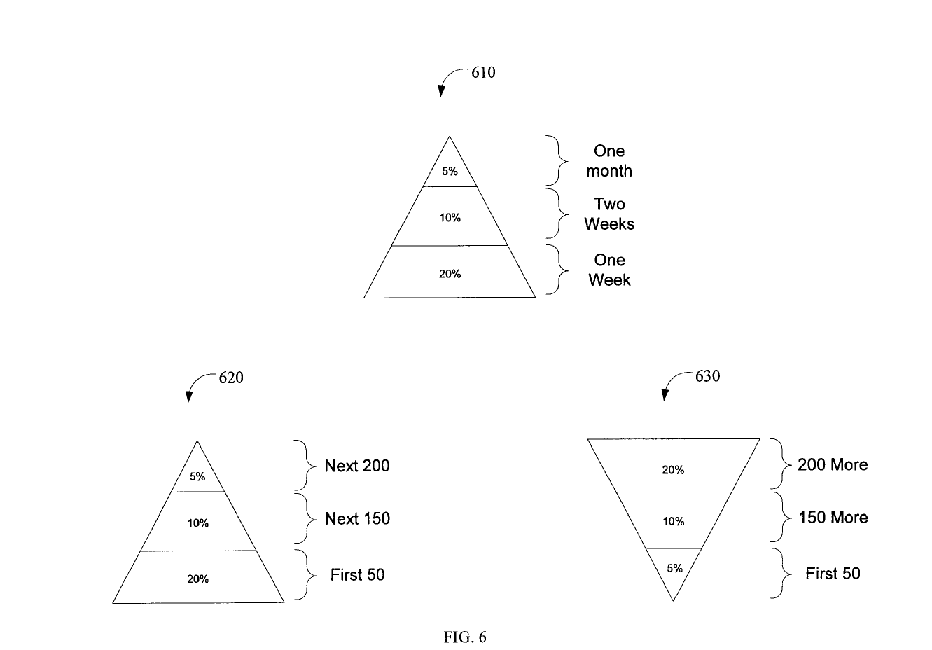

In some implementations of the invention, the incentive may be variable with respect to time or number of debtors who responded to the conditional debt resolution offer, as illustrated in more detail below in FIG. 6. In some implementations, the incentive may be higher to earlier responders than later responders, thereby incentivizing a debtor to act quickly to accept a conditional debt resolution offer.

In some implementations of the invention, conditional offer server 130 may keep secret a status of the conditional offer so that debtors who receive the conditional offer do not know whether the offer is still valid. In other implementations of the invention, conditional offer server 130 may communicate the status of the conditional offer. In some implementations, the status may include, for example, a time remaining for the conditional offer to be valid, an indication to start a timer when received at client device 150, a number of responses to the conditional offer that has been received, a number of responses that are remaining (i.e., a capped number minus the number of received responses), or a number of responses that must be received to make the conditional offer valid. In this manner, a debtor who received a conditional offer may be aware that the conditional offer is still valid. In some implementations, the status may be communicated in real-time (thereby providing real-time updates) or periodically (such as at regular intervals of time and/or number of responses that have been received).

According to various implementations of the invention, conditional offer server 130 may include a processor 132, a memory 134, and/or other components that facilitate the functions of conditional offer server 130 described herein. In some implementations of the invention, processor 132 includes one or more processors configured to perform various functions of conditional offer server 130. In some implementations of the invention, memory 134 includes one or more tangible (i.e., non-transitory) computer readable media. Memory 134 may include one or more instructions that, when executed by processor 132, configure processor 132 to perform the functions of conditional offer server 130.

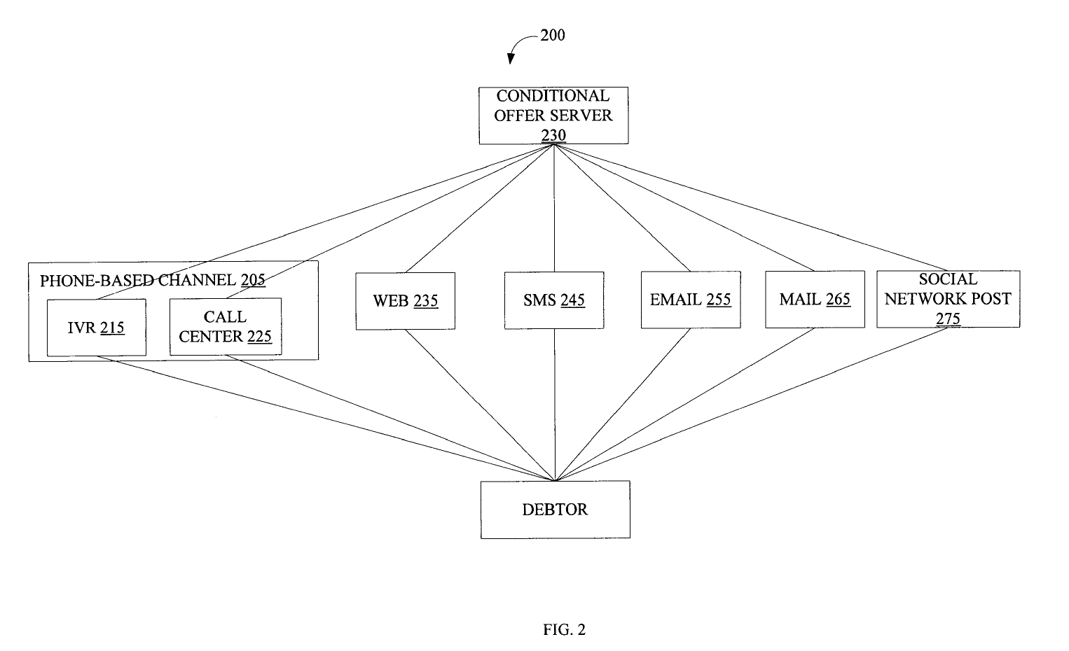

FIG. 2 is a block diagram illustrating various channels used by conditional offer server 230 for communicating conditional debt resolution offers, according to various implementations of the invention. In some implementations of the invention, conditional offer server 230 may use a phone-based channel 205 (including, but not limited to, an IVR channel 215, a call center channel 225, and/or other phone-based channels), a web channel 235, an SMS channel 245, an email channel 255, a mail channel 265, and a social network post channel 275. Whichever channel or a combination of channels in particular sequence is used, conditional offer server 230 may determine conditional debt resolution offers to be communicated to a debtor. In some implementations of the invention, conditional offer server 230 may receive responses such as acceptances in a format based on the type of channel being used (such as reading a web form when using web channel 235 or bubbled/circled responses when using mail channel 265).

In some implementations of the invention, conditional offer server 230 uses an IVR channel 215. In these implementations, conditional offer server 230 includes or otherwise uses an IVR system to communicate with a debtor. Via IVR channel 215, conditional offer server 230 may communicate one or more conditional debt resolution offers to the debtor. For example, a response to the conditional debt resolution offer may be made using a touch-tone phone to indicate an acceptance and/or method of payment. In other examples, the IVR system may record open-ended acceptances of the conditional debt resolution offer for speech-to-text or live analysis and data entry. In either case, conditional offer server 230 may receive acceptances/responses from the debtor to the conditional debt resolution offers via IVR channel 215.

In some implementations of the invention, conditional offer server 230 uses a call center channel 225. In these implementations, conditional offer server 230 may expose a call center interface that a call center agent (i.e., a human operator) uses to receive a conditional debt resolution offer to be communicated to the debtor. The call center agent may contact the debtor and offer the conditional debt resolution offer. In this manner, conditional offer server 230 may receive acceptances/responses to the conditional debt resolution offer from the debtor via the call center agent.

In some implementations of the invention, conditional offer server 230 uses a web page communication channel 235. In these implementations, conditional offer server 230 may expose a web page that communicates a conditional debt resolution offer and receives an acceptance/response from the debtor. In some implementations of the invention, the web page is secured and requires login credentials. For example, the debtor may be invited via various communication channels to visit the web page, login, and view/respond to the conditional debt resolution offer.

In some implementations of the invention, conditional offer server 230 uses a text message channel 245. In these implementations, conditional offer server 230 may include or otherwise use a text messaging service that communicates conditional debt resolution offers to debtors via text message to a debtor's device. In some implementations, acceptances/responses to the conditional debt resolution offers may be input by the debtor via reply text message(s). In some implementations, the text message may be secured by encryption and/or password protection. In some implementations, the text message may include a URL to a website, a phone number to call, or other resource identifier to view and/or accept the conditional debt resolution offer.

In some implementations of the invention, conditional offer server 230 uses an email channel 255. In these implementations, conditional offer server 230 may include or otherwise use an email service that communicates a conditional debt resolution offer to debtors via email to a debtor's email address. In some implementations, acceptances/responses to the conditional debt resolution offer may be input by the debtor via reply email. In some implementations, the email may include a URL to a website, a phone number to call, or other resource identifier to view and/or accept the conditional debt resolution offer.

In some implementations of the invention, conditional offer server 230 uses a mail channel 265. In these implementations, conditional offer server 230 may cause a conditional debt resolution offer to be mailed to debtors in hard copy to the debtor's mailing address. In some implementations, conditional offer server 230 may automatically read the acceptances/responses and/or the responses may be input to conditional offer server 230 by a human operator.

In some implementations of the invention, conditional offer server 230 uses a social network post channel 275. In these implementations, conditional offer sever 230 may cause a conditional debt resolution offer to be included in comments, private messages associated with the debtor's account with a social networking site. In some implementations, acceptances/responses to the conditional debt resolution offer may be input by the debtor via a response to the comments/private messages. In some implementations, a comment/private message may include a URL to a website, a phone number to call, or other resource identifier to view and/or accept the conditional debt resolution offer.

It will be understood that while FIG. 2 depicts IVR 215 and Call center 225 channels, other forms of phone-based channels (for example, dialers, debtor inbound calls, etc.) may also be used by conditional offer server 230 for communicating conditional debt resolution offers to debtors, without departing from the spirit of the invention.

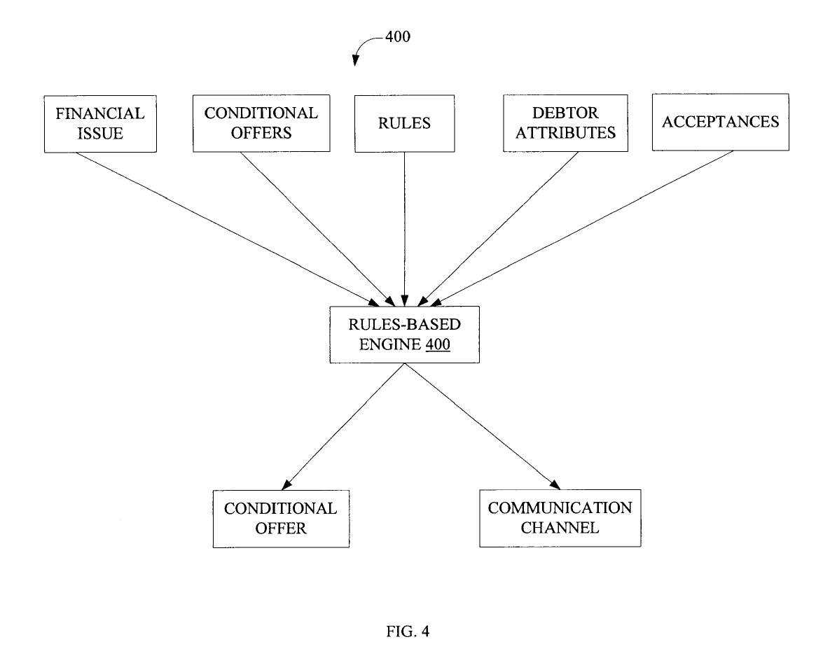

In some implementations of the invention, conditional offer server 230 may use a particular communication channel predicted to be most effective at communicating conditional debt resolution offers and/or obtaining responses, as discussed with respect to FIG. 4 below. In some implementations of the invention, conditional offer server 230 may use a combination of two or more channels to communicate conditional debt resolution offers and/or obtain responses. effectively communicated in one communication channel than another. In some implementations, conditional offer server 230 may use a particular sequence of two or more channels to communicate conditional debt resolution offers and/or obtain responses. For example, conditional offer server 230 may use email, SMS, and IVR channels, wherein the email channel may be used first to communicate conditional debt resolution offers and/or obtain responses, followed by the SMS channel, and then the IVR channel.

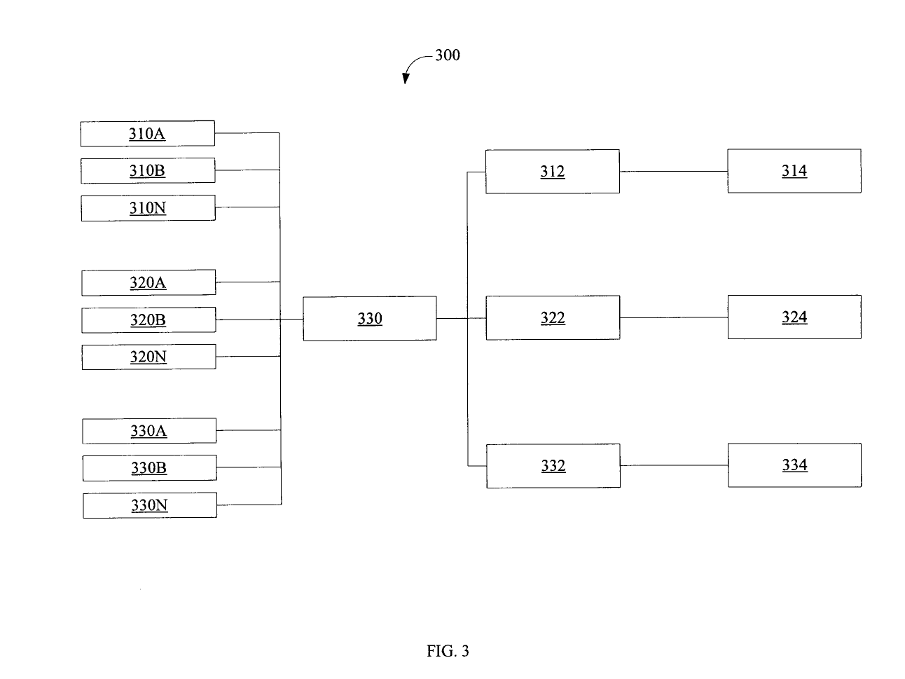

FIG. 3 is a block diagram 300 illustrating different groups of debtors 312, 322, 332 receiving different conditional debt resolution offers 314, 324, 334, according to various implementations of the invention. As illustrated in FIG. 3, conditional offer server 330 may group different debtors 310A-N, 320A-N, 330A-N into different groups 312, 322, 332. Because different debtors 310A-N, 320A-N, 330A-N may respond differently to conditional offers, in some implementations, each group 312, 322, 332 may receive a corresponding conditional debt resolution offer 314, 324, 334. For example, a group 312 of debtors may receive conditional debt resolution offer 314 that includes “10% off debt to the first 200 respondents” while another group 322 of debtors may receive conditional debt resolution offer 324 that includes “15% off debt if a reply is received in 10 days.” As would be appreciated, the foregoing non-limiting examples are meant to merely illustrate that different groups 312, 322, 332 of debtors may receive different conditional debt resolution offers 314, 324, 334. Other types of conditional debt resolution offers may be offered.

In some implementations of the invention, conditional offer server 330 may determine the different groups 312, 322, 332 based on a debtor attribute. For example, debtors 310A-N may have a history of contacting a creditor and/or conditional offer server 330 in order to resolve a debt. Based on this common debtor attribute, conditional offer server 330 may place debtors 310A-N into group 212. In this example, group 312 may be offered a smaller incentive than another group that includes debtors having less inclination to pay off a debt. In other words, in some implementations, a larger incentive may be provided to groups of debtors associated with debtors having less inclination to pay than for groups associated with debtors having more inclination to pay. In some implementations, conditional offer server 330 may determine groups 312, 322, 332 based on a rule and debtor attributes. In other words, a rule may encode logic that indicates how to form groups 312, 322, 332 using debtor attributes.

FIG. 4 is a block diagram illustrating a rules-based engine 400 for conditional debt resolution offers, according to various implementations of the invention. In some implementations of the invention, rules-based engine 400 may be implemented by a computing device such as conditional offer server 130, 230, 330 illustrated in FIGS. 1, 2, and 3.

In some implementations of the invention, rules-based engine 400 may obtain an indication of a type of financial issue, a plurality of conditional debt resolution offers, debtor attributes, and/or information associated with debtors. In some implementations of the invention, the plurality of conditional debt resolution offers or the plurality of rules may be customized by a creditor to which a debt is owed by a debtor. In some implementations of the invention, each of the rules may include logic (such as software or other instructions) that rules-based engine 400 uses in order to make decisions about which conditional debt resolution offers should be communicated to address financial issues. In other words, based on rules regarding a debtor and/or a debtor's account, rules-based engine 400 may determine different conditional debt resolution offers.

In some implementations of the invention, a rule may specify that a conditional debt resolution offer should be communicated over a particular communication channel, a combination of communication channels or a particular sequence of communication channels. For example, a rule may specify that a question should be communicated via a phone call for time-sensitive conditional debt resolution offers, may specify a particular communication channel that is determined to be effective at obtaining a response/acceptance to the conditional debt resolution offer, or may specify that a particular communication channel/particular combination or sequence of communication channels that is determined to be effective (for example, cost effective) at communicating conditional debt resolution offers and/or at obtaining response/acceptance to the conditional debt resolution offers.

In this manner, using the plurality of rules, rules-based decision engine 400 may determine which conditional debt resolution offers to communicate and/or how to communicate them. In some implementations of the invention, rules are not mutually exclusive. In other words, one rule may be used in combination with another rule.

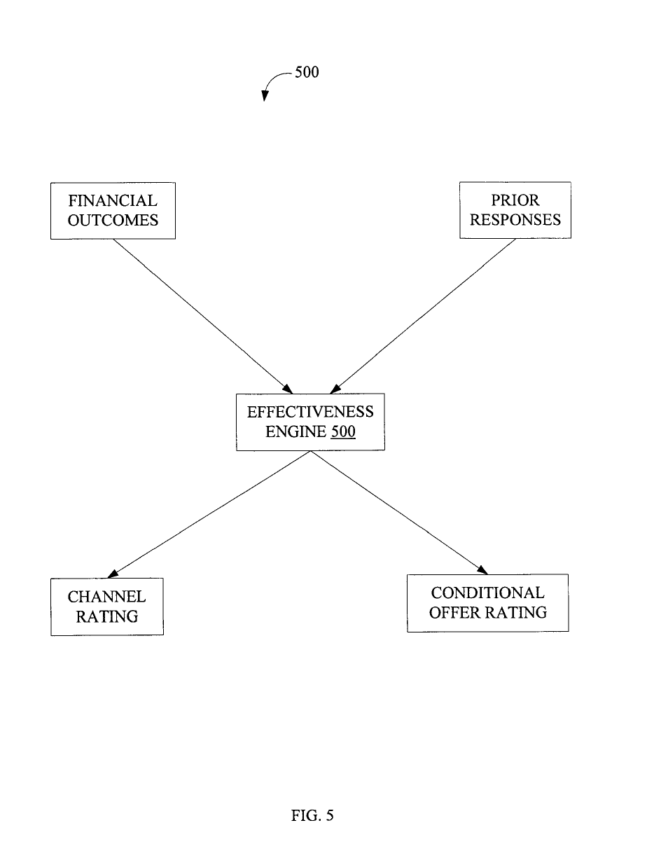

FIG. 5 is a block diagram illustrating an effectiveness engine 500 for rating effectiveness of conditional debt resolution offers or communication channels, according to various implementations of the invention. In some implementations of the invention, effectiveness engine 500 may be used by rules-based engine 400 illustrated in FIG. 4 in order to determine which conditional debt resolution offers to communicate and/or how to communicate them. For example, effectiveness engine 500 may be used to filter which conditional debt resolution offers to communicate based on a how effective a conditional debt resolution offer has performed (i.e., whether the conditional offer has been accepted or whether the conditional offer was validated) in the past. According to various implementations of the invention, effectiveness engine 500 may be implemented by a computing device such as conditional offer servers 130, 230, and 330 illustrated in FIGS. 1, 2, and 3.

In some implementations of the invention, effectiveness engine 500 may determine a score or ranking (hereinafter “rating”) for a conditional debt resolution offer and/or communication channel/combination of communication channels/particular sequence of communication channels. The rating may be determined based on various assessments for effectiveness described below.

In some implementations of the invention, effectiveness engine 500 may assess a conditional debt resolution offer for its effectiveness in obtaining responses. For example, effectiveness engine 500 may rate a conditional debt resolution offer based on whether the conditional debt resolution offer was accepted by a debtor. In some implementations, for example, a conditional debt resolution offer that receives two hundred acceptances may be rated lower than a conditional debt resolution offer that receives five hundred acceptances. In another example, a conditional debt resolution offer that receives a hundred acceptances in two weeks may be rated lower than another conditional debt resolution offer that receives a hundred acceptances in two days. Similarly, effectiveness engine 500 may assess a communication channel/combination of communication channels/particular sequence of communication channels based on its effectiveness in obtaining a response (i.e., whether a web page channel for a particular conditional debt resolution offer is more effective at obtaining a response than a telephone call, whether a combination of web page channel and telephone call is more effective at obtaining a response than a combination of web page channel and email channel, or whether a sequence of email followed SMS is more effective at obtaining a response that a sequence of SMS followed by email).

In some implementations of the invention, effectiveness engine 500 may rate a conditional debt resolution offer based on a final disposition or outcome of the financial issue associated with the conditional debt resolution offer. In other words, a rating may be based on whether the financial issue for which the conditional debt resolution offer is communicated was resolved.

In some implementations of the invention, effectiveness engine 500 may generate reports that illustrate effectiveness of conditional debt resolution offers and communication channels. Such reports may be accessed by creditors and others in order to determine strategies for dealing with debtors. For example, creditors may use the reports to generate updated rules based on which conditional debt resolution offers are more effective in different situations/financial issues.

FIG. 6 is a schematic representation of conditional debt resolution offers 610, 620, and 630 associated with different incentives, according to various implementations of the invention. Conditional debt resolution offer 610 illustrates providing a greater incentive to earlier responders to a debt recovery offer than to later responders. As illustrated, for example, conditional debt resolution offer 610 provides a 20% off discount to a debt owed if a response is received within a week, a 10% off discount if received within two weeks and a 5% discount if received within a month. Similarly, conditional debt resolution offer 620 illustrates providing greater incentive to earlier responders than to later responders. In this implementation, as illustrated by conditional debt resolution offer 620, the first 50 responders receive a 20% off discount, the next 150 responders receive a 10% off discount and the next 200 responders receive a 5% discount.

Conditional debt resolution offer 630 illustrates providing greater incentives as the number of responders increase. In this manner, as more debtors are interested in conditional debt resolution offer 630, the incentive increases. As illustrated, conditional debt resolution offer 630 provides a 5% off discount if 50 responses are received, a 10% discount if 150 more responses are received, and a 20% discount if 200 more responses are received.

In some implementations, each debtor receives the incentive associated with their response category (i.e., different debtors receive different incentives depending on when they responded). In other implementations, a debtor may receive an incentive associated with a different response category. In these implementations, for example, conditional debt resolution offer 630 may provide the same incentive to all debtors based on the latest number of responders.

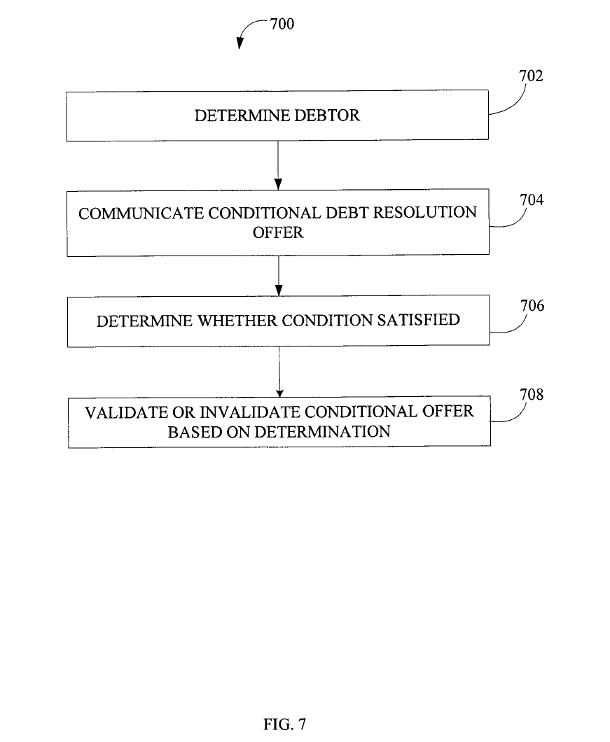

FIG. 7 is a flow diagram illustrating an example of a process 700 for providing a conditional debt resolution offer for resolving a debt, according to various implementations of the invention. The various processing operations and/or data flows depicted in FIG. 7 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 702, process 700 may include determining a debtor that is to receive a conditional debt resolution offer, which is subject to a condition for the conditional debt resolution offer to be valid. In some implementations, an incentive such as a discount off the debt owed, favorable credit bureau reporting, or other incentive may be included with the conditional debt resolution offer. In some implementations, the conditional debt resolution offer when valid and accepted by the debtor at least partially resolves the debt. For example, a debtor may be offered a limited-time offer to pay off a debt. If accepted before an expiration time/date, the debtor may receive a discount off the debt owed. The limited-time offer is valid only if accepted before an expiration period.

In some implementations of the invention, in an operation 704, process 700 may include causing the conditional debt resolution offer to be communicated to the debtor. For example, the conditional debt resolution offer may be communicated via a web page, a text message that links to a web page, and/or via other communication channel, combination of communication channels, or sequence of communication channels.

In some implementations of the invention, in an operation 706, process 700 may include determining whether the condition has been satisfied. For example, in operation 706, process 700 may determine whether a time period for response has expired, whether a maximum number of responses has already been received, whether a minimum number of responses has been received, or other determination of whether a condition has been satisfied.

In some implementations of the invention, in an operation 708, process 700 may include validating the conditional debt resolution offer when the condition has been satisfied or invalidating the conditional debt resolution offer when the condition has not been satisfied. For example, a conditional debt resolution offer is valid if a response from a debtor is received on or before an expiration date whereas the offer is invalid if the response is received after the expiration date. In some implementations, process 700 may validate the conditional debt resolution offer before and/or after a response is received (such as periodically checking whether an expiration date has passed).

Implementations of the invention may be made in hardware, firmware, software, or any suitable combination thereof Implementations of the invention may also comprise instructions stored on a machine-readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

1. A computer-implemented method for providing a conditional debt resolution offer, comprising:
receiving debtor eligibility criteria defining criteria for qualifying for inclusion in a group of qualifying debtors to receive a conditional debt resolution offer;
determining, by a computing device, the group of qualifying debtors that are to receive the conditional debt resolution offer based at least in part on a comparison between the debtor eligibility criteria and at least one debtor attribute for each of a plurality of available debtors in a database of debtors, wherein the conditional debt resolution offer (1) is valid when at least one condition associated with the conditional debt resolution offer is met, and (2) when valid and accepted by a qualifying debtor in the determined group of qualifying debtors at least partially resolves a debt of the qualifying debtor;
electronically communicating the conditional debt resolution offer to the determined group of qualifying debtors;
responsive to receipt of a response by a responding debtor from the determined group of qualifying debtors, determining, based at least in part on comparison between an attribute of the response and the at least one condition, whether the at least one condition has been satisfied for the responding debtor;
electronically communicating that the conditional debt resolution offer is valid for the responding debtor in an instance in which it is determined that the at least one condition has been satisfied for the responding debtor; and
electronically communicating that the conditional debt resolution offer is invalid for the responding debtor in an instance in which it is determined that the at least one condition has not been satisfied for the responding debtor.

2. The computer-implemented method of claim 1, further comprising:
receiving, by the computing device, an indication that the conditional debt resolution offer has been accepted by the responding debtor;
communicating that at least a partial resolution of the debt based on the conditional debt resolution offer has been achieved in an instance in which a valid conditional debt resolution offer has been accepted; and
communicating a rejection of the conditional debt resolution offer in an instance in which an invalid conditional debt resolution offer has been accepted.

3. The computer-implemented method of claim 1, wherein the at least one condition comprises a time limit associated with an expiration of the conditional debt resolution offer.

4. The computer-implemented method of claim 1, wherein satisfaction of the at least one condition is a function of a number of responses received from the determined group of qualifying debtors receiving the conditional debt resolution offer.

5. The computer-implemented method of claim 1, wherein the at least one condition comprises a minimum number of acceptances by the determined group of qualifying debtors, the minimum number being associated with a number of the determined group of qualifying debtors that must accept the conditional debt resolution offer.

6. The computer-implemented method of claim 1, further comprising:
communicating, by the computing device, an incentive to accept the conditional debt resolution offer.

7. The computer-implemented method of claim 6, wherein the incentive comprises a discount off the debt.

8. The computer-implemented method of claim 6, wherein the incentive is subject to an incentive condition for the incentive to be valid.

9. The computer-implemented method of claim 8, wherein the incentive condition comprises an incentive time limit associated with an expiration of the incentive.

10. The computer-implemented method of claim 8, wherein the incentive is communicated to a plurality of debtors in the determined group of qualifying debtors, and wherein the incentive condition comprises a maximum number of acceptances by the plurality of debtors to which the incentive is communicated, the maximum number being associated with a cap on a number of the plurality of debtors to which the incentive is communicated that may are permitted to receive the incentive.

11. The computer-implemented method of claim 8, wherein the incentive is communicated to a plurality of debtors in the determined group of qualifying debtors, and wherein the incentive condition comprises a minimum number of acceptances by the plurality of debtors to which the incentive is communicated, the minimum number being associated with a minimum number of the plurality of debtors to which the incentive is communicated that must accept the incentive for the incentive to be valid.

12. The computer-implemented method of claim 1, further comprising:
communicating, by the computing device, a status of the conditional offer, wherein the status comprises one or more of: a time remaining for the conditional offer to be valid or a number of responses to the conditional offer.

13. A system for providing a conditional debt resolution offer, comprising:
one or more processors configured to:
receive debtor eligibility criteria defining criteria for qualifying for inclusion in a group of qualifying debtors to receive a conditional debt resolution offer;
determine, based at least in part on a comparison between the debtor eligibility criteria and at least one debtor attribute for each of a plurality of available debtors in a database of debtors, the group of qualifying debtors that are is to receive the conditional debt resolution offer, wherein the conditional debt resolution offer (1) is valid when at least one condition associated with the conditional debt resolution offer is met, and (2) when valid and accepted by a qualifying debtor in the determined group of qualifying debtors at least partially resolves a debt of the qualifying debtor;
electronically communicate the conditional debt resolution offer to the determined group of qualifying debtors;
determine, in response to receipt of a response by a responding debtor from the determined group of qualifying debtors, whether the at least one condition has been satisfied for the responding debtor based at least in part on a comparison between an attribute of the response and the at least one condition;
electronically communicate that the conditional debt resolution offer is valid for the responding debtor an instance in which it is determined that the at least one condition has been satisfied for the responding debtor; and
electronically communicate that the conditional debt resolution offer is invalid for the responding debtor in an instance in which it is determined that the at least one condition has not been satisfied for the responding debtor.

14. The system of claim 13, wherein the one or more processors are further configured to:
receive an indication that the conditional debt resolution offer has been accepted by the responding debtor;
electronically communicate that at least a partial resolution of the debt based on the conditional debt resolution offer has been achieved in an instance in which a valid conditional debt resolution offer has been accepted; and
communicate a rejection of the conditional debt resolution offer in an instance in which an invalid conditional debt resolution offer has been accepted.

15. The system of claim 13, wherein the at least one condition comprises a time limit associated with an expiration of the conditional debt resolution offer.

16. The system of claim 13, wherein satisfaction of the condition is a function of a number of responses received from the determined group of qualifying debtors receiving the conditional debt resolution offer.

17. The system of claim 13, wherein the condition comprises a minimum number of acceptances by the determined group of qualifying debtors, the minimum number being associated with a number of the determined group of qualifying debtors that must accept the conditional debt resolution offer.

18. The system of claim 13, wherein the one or more processors are further configured to: communicate an incentive to accept the conditional debt resolution offer.

19. The system of claim 18, wherein the incentive comprises a discount off the debt.

20. The system of claim 18, wherein the incentive is subject to an incentive condition for the incentive to be valid.

21. The system of claim 20, wherein the incentive condition comprises an incentive time limit associated with an expiration of the incentive.

22. The system of claim 20, wherein the incentive is communicated to a plurality of debtors in the determined group of qualifying debtors, and wherein the incentive condition comprises a maximum number of acceptances by the plurality of debtors to which the incentive is communicated, the maximum number being associated with a cap on a number of the plurality of debtors to which the incentive is communicated that may are permitted to receive the incentive.

23. The system of claim 20, wherein the incentive is communicated to a plurality of debtors in the determined group of qualifying debtors, and wherein the incentive condition comprises a minimum number of acceptances by the plurality of debtors to which the incentive is communicated, the minimum number being associated with a minimum number of the plurality of debtors to which the incentive is communicated that must accept the incentive for the incentive to be valid.

24. The system of claim 13, wherein the one or more processors are further configured to:
communicate a status of the conditional offer, wherein the status comprises: one or more of a time remaining for the conditional offer to be valid or a number of responses to the conditional offer.

25. A computer-implemented method for providing a conditional debt resolution offer, comprising:
electronically communicating to a plurality of qualifying debtors a conditional debt resolution offer, wherein the conditional debt resolution offer (1) is valid when at least one condition associated with the conditional debt resolution offer is met, and (2) when valid and accepted by a qualifying debtor from the plurality of qualifying debtors at least partially resolves a debt of the qualifying debtor;
in response to receipt of a response by a responding debtor from the plurality of qualifying debtors, determining, by a computing device, whether the at least one condition has been satisfied for the responding debtor based at least in part on a comparison between an attribute of the response and the at least one condition;
electronically communicating that the conditional debt resolution offer is valid for the responding debtor in an instance in which it is determined that the at least one condition has been satisfied for the responding debtor; and
electronically communicating that the conditional debt resolution offer is invalid for the responding debtor in an instance in which the at least one condition has not been satisfied for the responding debtor.
